(19) United States
(12) Patent Application Publication
(10) Pub. No.: US 2005/0078055 A1
(43) Pub. Date: Apr. 14, 2005

(54) Colour projector

(76) Inventor: Peter Wynne Willson, London (GB)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/498,465

(22) PCT Filed: Dec. 10, 2002
(86) PCT No.: PCT/GB02/05580

(30) Foreign Application Priority Data
Dec. 10, 2001 (GB) 0129494.1

(51) Int. Cl. G09G 3/00

(52) U.S. Cl. 345/32

(57) ABSTRACT

In a projector using a digital image generator of rectangular form, such as a digital micro-mirror device (DMD), the input light beam striking the image generator defines a beam section of greater sectional area than an intended circular beam, so as to increase the number of digital elements of the image generator contributing to the light beam output. An optical arrangement, such as a mask, defines the beam section, which may be elliptical, or pincushion like, rather than circular. A lens, or other optical component, corrects the beam shape produced by the mask to the circular beam shape. Alternatively, a fiber-optic bundle replaces the mask and lens arrangement.

This invention is directed to the creation of lighting effects, and in particular aspects to the use in creating lighting effects of digital image projectors such as those used widely for graphics or video projection.

The image generator or modulator used in known digital image projectors takes a wide variety of forms employing known digital imaging techniques. A particularly convenient technology used in graphics or video projection is the digital micro-mirror technology of Texas Instruments (DMD).

A characteristic of the DMD and most other digital image generation technology is an inherently rectangular geometry often linked to a 4:3 or 16:9 aspect ratio common to video display. It is of course common in stage lighting and similar applications to require a beam of circular section. Whilst a circular image can of course be digitally created, this brings unexpected problems.

It is hence an object of the invention to provide a improved projection system for such stage lighting applications.

Accordingly, in one aspect the invention therefore consists in a projector for producing a light beam of substantially circular section, comprising: a digital image generator of substantially rectangular form; and an optical arrangement associated with the image generator, the optical arrangement defining a beam section of greater sectional area than the intended circular beam, such as to increase the number of digital elements of the image generator contributing to the light beam output, and correcting the beam shape to a circular beam shape.

In one form of the invention, the optical arrangement comprises a mask for defining the beam section, and a lens for correcting the beam shape to the circular beam shape. In another form, the optical arrangement comprises a fibre-optic bundle.

The use of a beam section larger than the circular beam allows more of the pixels of the DMD to be used to produce the output, creating a higher intensity image, or increasing efficiency.

Another aspect of the invention consists in a projector for producing a light beam of defined section, comprising a digital image generator of rectangular form and an optical mask arrangement associated with the image generator, the mask arrangement having an inactive configuration in which the beam section is governed by the image generator and an active configuration in which the beam section is governed by the mask.

Preferably, the defined section is circular.

The significant advantage of using an optical mask to define the (usually) circular section of the beam, is that full black can be achieved at the beam perimeter, rather than the “video black” which is achievable from the image generator itself.

Suitably, the mask has a window, for defining the beam section, of either elliptical or pincushion shape. The principal axes of the ellipse should typically be aligned with the axes of the rectangular image generator.

Advantageously, the optical means comprises a cylindrical lens.

Suitably, image data received by the image generator is distorted to pre-compensate for the effect on the image of the optical means.

Numerous methods for image projection are of course known in the art. In general, two distinct methods for the introduction of colour into projectors are known. First, a combination of projectors or projection elements, each producing a different colour, is employed, in order to create the desired effect. For example, the output from separate red, green and blue projectors may be combined to form a colour image, the RGB components of the image being separated and sent to the respective projectors.

Second, a single projector is used. Either an image generator is used which is inherently full colour or, more usually, a single, monochrome image generator is multiplexed between red, green and blue illumination. For example, a colour wheel may be employed having segments for the different colours, with the image generator being supplied with the respective colour separations, synchronously with red, green and blue illumination.

It has been recognized by the inventors that such projectors can have an entirely different use in theatrical lighting. Here, the projected image may include graphics or video, with the versatility of the digital image generator enabling a wide range of stationary or moving patterns to be generated, in ways which would be very difficult or impossible with conventional stage lighting. At other times, such digital projectors may be needed to create more traditional effects, such as the monochrome illumination of actors and stage sets with a plain beam or with a mask or gobo effect created using the power of the digital image generator.

It is therefore an object of a further aspect of the invention to provide a projection system which is capable of providing a broader range of effects.

Accordingly, the present invention consists in one aspect in a colour projection device comprising a light source, a plurality of light modulating means and colour filtering means associated with each respective light modulating means and operating on respective portions of the colour spectrum, whereby the respective light modulating means and colour filtering means cooperate to form a combined output, wherein the colour filtering means is actuatable between active and inactive positions, whereby light from the light source encountering a respective light modulating means is modulated when the respective colour filtering means is in the active position.

This system therefore has the significant advantage that, in one example, red, green and blue colour filters may be removed from the respective light modulators, allowing unfiltered light from all three light modulators to form an output picture having much greater intensity.

Suitably, a colour filtering means associated with a given light modulating means provides a plurality of different colours for output light. Preferably, the plurality of colours comprises a primary colour specific to that light modulator, and a range of custom colours common to all light modulators. In this way, there is added to the options of a colour image and a high intensity white beam, the additional option of a high intensity monochrome beam according to any one of the custom colours. Conveniently, the colour filtering means comprises a colour wheel.

A further aspect of the invention consists in a colour projection device comprising three image generators each adapted to receive a respective colour separated digital image signal; and an optical arrangement such that the separate image generators operate on different regions of the colour spectrum to deliver in combination a projected colour image; characterized in that the optical arrangement is further provided with a lighting mode in which the three image generators operate on the same region of the colour spectrum to deliver a high intensity monochrome image beam.

The invention will now be described by way of example with reference to the accompanying drawings, in which:

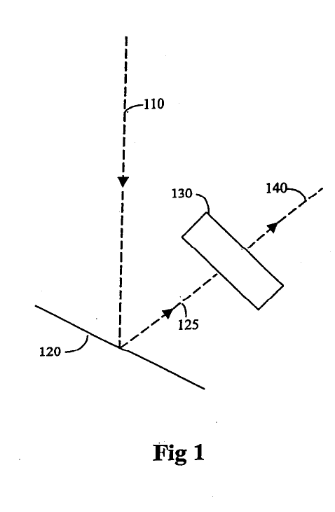

FIG. 1 is a diagram illustrating a light modulator and filter mask of a projector according to an embodiment of the invention;

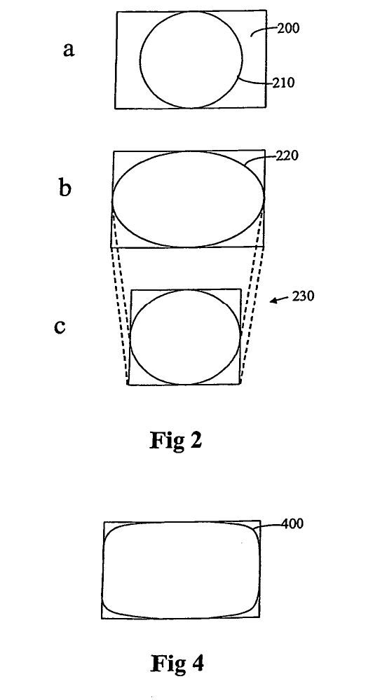

FIG. 2 is a diagram of a filter mask according to an embodiment of the invention;

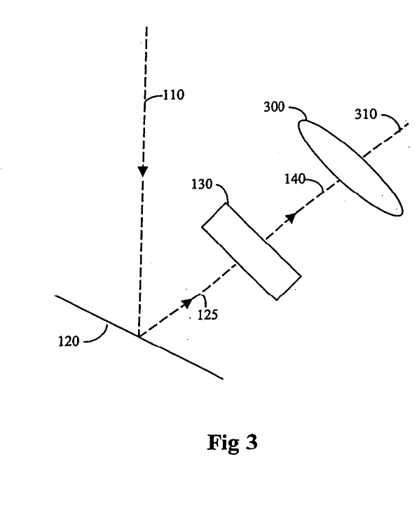

FIG. 3 is a diagram illustrating a light modulator, filter mask and lens arrangement of a projector according to an embodiment of the invention;

FIG. 4 is a diagram of a filter mask according to another embodiment of the invention.

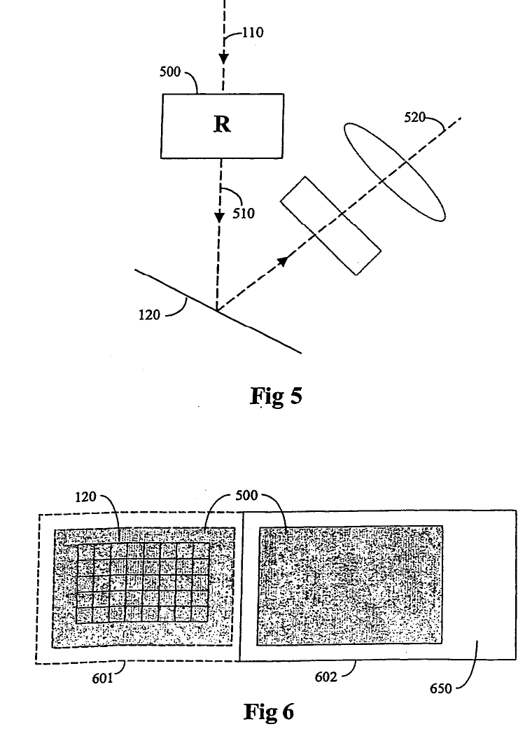

FIG. 5 is a diagram of a single light modulator of a three-chip type projector according to an embodiment of the invention.

FIG. 6 is a diagram illustrating a colour filter according to an embodiment of the invention; and

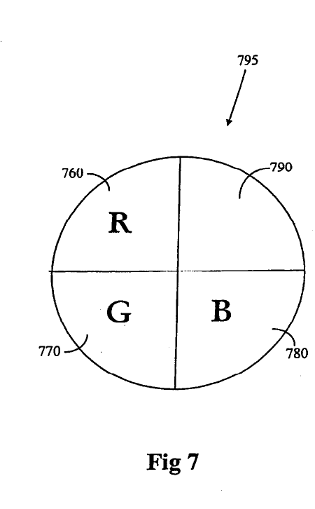

FIG. 7 is a diagram of a colour wheel according to an embodiment of the invention.

FIG. 1 shows a DMD projector having a filter mask system according to an embodiment. Light (110) from a light source (not shown) is received and reflected by the DMD (120). The image generated on the DMD is thus incorporated into the light beam to produce an image bearing beam (125). This image bearing beam then passes through a filter mask (130) to produce the projection beam (140) which continues towards the projection lens (not shown) to produce the final output.

An embodiment of the invention is illustrated in FIG. 2. It is a common requirement of stage and other lighting effects that the projected beam be circular. A typical mask (200) for a colour filter, as shown at “a” in FIG. 2 will therefore have a circular window (210). Since DMD's (and most digital image generators) are typically rectangular, such a mask restricts the output of the DMD and enables full black to be achieved at the beam perimeter. This mask is conveniently located in essentially the same plane as the image generator itself.

In one embodiment of the invention, the window is elliptical (220) in order that a greater percentage of the discrete mirror elements of the DMD contributes to the beam. Subsequently, in order to correct the ellipsoidal effect, the beam is passed through an anamorphic lens, producing a circular beam profile (230).

Such an arrangement is illustrated in FIG. 3. The light (110) is reflected from the DMD (120) and passes through the filter mask (130), which has a non-circular window. The output beam (140) is then optically corrected by the lens (300), to produce the output projection beam (310), having the desired circular profile (230).

The image data input to the DMD may be pre-processed in order to compensate for the effect on the image of this change in beam shape. For example, the image may be distorted to fit an elliptical shape, thus the image will itself be corrected by the lens (300) to its non-distorted form.

Pixels in the centre of the image will typically not be significantly corrected, but pixels at the lateral edges of the image may be combined or overlapped with several neighbouring pixels in the corrected output image. In one embodiment, the processing alters the gray-scale of areas of the image which will be corrected more, so that once the corrected image is formed, these areas do not appear darker or lighter than the rest of the image, due to the combination or overlapping of pixels from the enlarged elliptical window.

Other shapes may also be employed in the window of the mask in order to increase the total light output. For example, the so-called “pincushion” shape of the window (400) of FIG. 4 may be used. Optical means is then employed to return the beam section to circular form, though this may require a series of lenses, rather than a single anamorphic lens. Typically, the image data will be pre-processed to compensate for the correction.

It should be noted that the invention is not restricted to the production of a circular beam. A variety of beam shapes may be employed, with a variety of optical means employed to increase the number of DMD pixels contributing to the output.

For example, a fibre-optic bundle may be employed to replace the mask and lens arrangement. An input end of the bundle is positioned before the DMD and arranged in a rectangular ferrule, each fibre associated with a pixel of the DMD. At the output end, the fibres are arranged in a circular (or other shaped) ferrule.

In one embodiment, the fibres are arranged randomly between the input and output ferrules, so that pixels of the image input to the DMD are no longer in the correct position in the image beam, producing a novel lighting effect.

Furthermore, the invention is not restricted to use of DMDs; any of the digital image generation devices known to the art may be employed.

In a further embodiment of the invention, the example is used of a projector having three DMD light modulators—a so-called three chip system although it should be noted that a variety of projector types may be used in embodiments of the invention.

FIG. 5 shows for convenience a single DMD of a three-chip projector having a filter system according to an embodiment. Light (110) from a light source (not shown) is passed through a filter (500), producing a coloured beam (510). This is received and reflected by the DMD (120). The image generated on the DMD is thus incorporated into the light beam to produce an image bearing beam (520), which continues towards the projection lens (not shown) to produce the final output.

In this diagram, the filter is a red (R) filter, producing the red component of the colour picture to be produced by the projector. Thus two other DMDs, one having a green filter, the other a blue filter, are incorporated into the apparatus, functioning in the same way. The RGB outputs are then combined to form the colour image output of the projector.

Also in this diagram, the filter (500) is positioned before the DMD (120). In such embodiments, the DMD is prevented from further excessive heating, as the filter removes some of the light intensity. However, in alternative embodiments, the filter is positioned in the path of light exiting the DMD.

Referring to FIG. 6, each filter (500) may be moved from an engaged position (601) to a disengaged position (602) in front of the DMD (120). This allows the output of the particular DMD to be either the usual colour (R, G or B) output or a non-filtered output. In one embodiment of the invention, this engaged/disengaged shutter type arrangement is used when a white light output is required in addition to the normal coloured image. If all three filters are removed from the respective DMD chips, no colour will be present in the output, but a high intensity white beam will be formed, carrying in monochrome any image (or the aggregate of any image) defined by the DMD.

The increase in intensity from utilising all three chips may be large enough that the desired output intensity can be achieved using lower resources. For example, the light source could simply be dimmed for monochrome projection, lowering power consumption. The chips could be actuated for shorter periods, again saving power, and reducing heat intensity and wear on the DMDs over long periods of use.

In the embodiment shown in FIG. 6, the filter (500) is engaged and disengaged by means of a shutter (650) moved back and forth in front of the DMD. This shutter could be activated by any simple mechanical or electronic means known to those skilled in the art.

In certain embodiments, the shutters for each of the RGB filters may be linked, or at least cooperatively actuated, so that the picture is either full colour, with all filters engaged, or full black/white, with no filters engaged.

Further effects may be achieved through use of colour wheels, such as that shown in FIG. 7. The example shown in FIG. 7 is a wheel (795) separated into red (760) green (770) blue (780) and “white” (790) quadrants. The “white” quadrant may be a colourless filter, or merely a hole in the colour wheel. In the “normal” mode, the colour wheels for the respective DMD chips are set to R, G and B respectively. For a black/white beam, all three wheels are set to “white”. Additionally, for a monochrome red (or blue or green) beam, all three wheels are set to red (or blue or green). In a preferred form, each colour wheel (or alternative arrangement for bringing colour filters into the optical path) will comprise:
one section taking the primary colour specific to the image generator;
one transparent or “white” section; and
a plurality of custom colours which are common to all image generators.

The custom colours common to each wheel allow the creation of monochrome beams, with all three wheels set to the custom colour, in colours other than the primary colours on the wheel.

Colour wheels may, in certain applications, make inefficient use of input light. It has therefore been proposed, for example in U.S. Pat. No. 6,324,006, that part of the light which falls on the colour wheel, but which is not used to produce the output, may be recaptured. Such methods of recapture or reuse of otherwise wasted light will find application in aspects of the present invention, not least those directed to maximizing the output intensity.

It will be appreciated by those skilled in the art that the invention has been described by way of example only, and a wide variety of alternative approaches may be adopted. In particular, it should be noted that the various embodiments described may be employed in combination. For example, the filter masks described with reference to FIGS. 1 to 4 may be employed with a single-chip projector, or with a three-chip projector, either of which employing the colour filters as described with reference to FIGS. 5 to 7.

1. A projector for producing a light beam of substantially circular section, comprising: a digital image generator of substantially rectangular form; and an optical arrangement associated with the image generator, the optical arrangement defining a beam section of greater sectional area than the intended circular beam, such as to increase the number of digital elements of the image generator contributing to the light beam output, and correcting the beam shape to a circular beam shape.

2. A device according to claim 1, wherein image data received by the image generator is are distorted to pre-compensate for the effect on the image of the optical arrangement.

3. A device according to claim 1, wherein the optical arrangement comprises a mask for defining the beam section, and a lens for correcting the beam shape to the circular beam shape.

4. A device according to claim 1, wherein the optical arrangement comprises a fiber-optic bundle.

5. A projector for producing a light beam of defined section, comprising a digital image generator of rectangular form and an optical mask arrangement associated with the image generator, the mask arrangement having an inactive configuration in which the beam section is governed by the image generator and an active configuration in which the beam section is governed by the mask.

6. A projector according to claim 5, wherein the section is circular.

7. A color projection device according to claim 1, wherein the mask has a window, for defining the beam section, of substantially elliptical shape.

8. A color projection device according to claim 1, wherein the mask has a window, for defining the beam section, of substantially pincushion shape.

9. A color projection device comprising a light source, a plurality of light modulators and a color filter associated with each respective light modulator and operating on respective portions of the color spectrum, whereby the respective light modulator and color filters cooperate to form a combined output, wherein the color filters are actuatable between active and inactive positions, whereby light from the light source encountering a respective light modulator is modulated when the respective color filter is in the active position.

10. A color projection device according to claim 9, wherein the respective color filters produce the colors red, green, and blue, respectively.

11. A color projection device according to claim 9, wherein a color filter associated with a given light modulator provides a plurality of different colors for monochrome output light.

12. A color projection device according to claim 10, wherein the color filter comprises a color wheel.

13. A color projection device according to claim 12, wherein the active position is achieved when colored sections of the wheel produce the output light, and wherein the inactive position is achieved where a section of the wheel passes the output light transparently.

14. A color projection device according to claim 9, further comprising an optical mask.

15. A color projection device according to claim 14, wherein the mask has a window of substantially elliptical shape.

16. A color projection device according to claim 14, wherein the mask has a window of substantially pincushion shape.

17. A color projection device comprising three image generators each adapted to receive a respective color separated digital image signal; and an optical arrangement such that the separate image generators operate on different regions of the color spectrum to deliver in combination a projected color image; wherein the optical arrangement is further provided with a lighting mode in which the three image generators operate on the same region of the color spectrum to deliver a high intensity monochrome image beam.

18. A device according to claim 17, wherein the image generators comprise a digital micro-mirror device.

19. A method for producing an output light beam of desired beam shape, comprising: generating an input light beam having a beam shape defining a larger cross-sectional area than said desired beam shape; employing an image generator to modulate the input light beam so as to maximize the number of digital elements of the generator contributing to the light output; and correcting the resultant image beam to the desired beam shape.

20. A method according to claim 19, comprising processing image data input to the image generator to pre-compensate for the correction of the image beam.

21. A device according to claim 9, wherein the light modulator comprises a digital micro-mirror device.

22. A color projection device according to claim 5, wherein the mask has a window, for defining the beam section, of substantially elliptical shape.

23. A color projection device according to claim 5, wherein the mask has a window, for defining the beam section, of substantially pincushion shape.
